(19) United States
(12) Patent Application Publication
(10) Pub. No.: US 2004/0254002 A1
(43) Pub. Date: Dec. 16, 2004

(54) Clamping device for mobile phones

(76) Inventor: Wen-Feng Tsay, Taipei (TW)

Correspondence Address: WEN-FENG TSAY, P. O. BOX 24-108, TAIPEI, TW

(21) Appl. No.: 10/460,012

(22) Filed: Jun. 13, 2003

(51) Int. Cl. H04M 1/00

(52) U.S. Cl. 455/575.9; 455/575.1

(57) ABSTRACT

The present invention discloses an improved clamping device for mobile phones, comprising an adapting base connected to an internal circuit at the lower end of a clamping base, and an inserting base with a connector electrically coupled to the upper end of the clamping base by means of an embedding engagement, a base surface with different levels at the front and the back disposed inside the clamping base, and a compression spring disposed between the front and the back levels and sliding along a groove of a contractible clamp seat. A side portion on each of the two sides of the clamp seat is protruded outside the clamping base. Unidirectional rack teeth aslant towards one side are disposed respectively on both sides of the clamp seat, and an elastic secure seat is disposed on the side of the rack teeth. The secure seat uses an upper stop element and a lower stop element to project into the rack teeth of the clamp seat and stack onto the secure seat, such that the clamp seat can only displace and clamp inwardly for the fixing. The rear end of the secure seat has a slanting notch, and the slanting notch has an elastic press rod, and the press rod also defines the corresponding slanting notch to drive the secure seat to move back and forth, to constitute an easy replaceable connecting structure of the adapting base and the stacking connection of the camp seat to match with the change of different adapting base without changing the volume of the clamping base and increase the range of contraction and expansion and width of the clamp seat in order to quickly and conveniently adjust the clamp and release of mobile phone, PDA, or palm game, extend the scope of application and applicability, and prevent economic waste and reduce large inventory.

### BACKGROUND OF THE INVENTION

1. Field of the Invention

The present invention relates to an improved clamping device for mobile phones, aiming at providing a clamping device for mobile phones but not limited to clamping one type of mobile phones due to the limited clamping width, and thus overcoming the shortcomings on applicability and convenience. The improved clamping device comprises an adapting base at the lower end of the clamping base for clamping and being connected to the internal circuit, and electrically coupled to the socket of the insert socket at the upper end by embedding engagement, and a base surface with different levels at the front and the back disposed inside the clamping base, and a compression spring disposed between the front and the back levels and sliding along a groove of a contractible clamp seat. A side portion on each of the two sides of the clamp seat is protruded outside the clamping base. Unidirectional rack teeth aslant towards one side are disposed respectively on both sides of the clamp seat, and an elastic secure seat is disposed on the side of the rack teeth. The secure seat uses an upper stop element and a lower stop element to project into the rack teeth of the clamp seat and stack onto the secure seat, such that the clamp seat can only displace and clamp inwardly for the fixing. The rear end of the secure seat has a slanting notch, and the slanting notch has an elastic press rod, and the press rod also defines the corresponding slanting notch to drive the secure seat to move back and forth, to constitute an easy replaceable connecting structure of the adapting base and the stacking connection of the camp seat to match with the change of different adapting base without changing the volume of the clamping base and increase the range of contraction and expansion and width of the clamp seat in order to quickly and conveniently adjust the clamp and release of mobile phone, PDA, or palm game, extend the scope of application and applicability, and prevent economic waste and reduce large inventory.

2. Description of the Related Art

Since the applications of mobile phones, PDAs, or palm games are getting more popular day after day, a clamping device is prepared for the convenience on the their applications in a car. Since the size of these devices are different, it is necessary to have different sets of clamping bases, which causes inconvenience and increase of cost. The invention as disclosed in the U.S. Pat. No. 5,903,645 by the invention is one of the examples. For the purpose of driving safety, many countries have already prohibited drivers to use mobile phones when they are driving. Further, either the power supply or the battery charging for mobile phones, PDAs, or palm games is through the battery of the car for the convenience and safety. Therefore, a batter charger or hand-free earphone for mobile phones is equipped in a car, and thus increasing the number of accessories. In addition to the economic effect, such accessory also occupies space and create a chaotic look. Furthermore, since the specifications and styles of the sockets are different, therefore each battery charger or hand-free earphone is designed for a single model and applicable for one model only. When there is a change in brand or model, it is necessary to purchase a new device. However, there are about 10 major mobile phone manufacturers, each manufacture has its own connectors with different models. Additionally, new models with new functions of mobile phones are introduced to the market unceasingly, and users go for the fashion and change their mobile phone all the time. Therefore, dumpling the whole set of the old phone and purchasing a new one are common, which is wasteful and pitiful. The prior art is also inconvenient and troublesome to the manufacturer's inventory, and thus requires improvements.

In view of the above description, the present inventor herein with many years of practical experience in the design, development, and manufacturing of mobile phone clamping device enhanced the traditional design and overcame the above shortcomings by performing a series of researches and developments and finally succeeded to invent the “Improved clamping device for mobile phones” according to the present invention.

### SUMMARY OF THE INVENTION

The primary objective of the present invention is to provide an improved clamping device for mobile phones, comprising a base surface with different levels at the front and the back disposed inside the clamping base, and a compression spring disposed between the front and the back levels and sliding along a groove of a contractible clamp seat. A side portion on each of the two sides of the clamp seat is protruded outside the clamping base. Unidirectional rack teeth aslant towards one side are disposed respectively on both sides of the clamp seat, and an elastic secure seat is disposed on the side of the rack teeth. The secure seat uses an upper stop element and a lower stop element to project into the rack teeth of the clamp seat and stack onto the secure seat, such that the clamp seat can only displace and clamp inwardly for the fixing. The rear end of the secure seat has a slanting notch, and the slanting notch has an elastic press rod, and the press rod also defines the corresponding slanting notch to drive the secure seat to move back and forth, to constitute an easy replaceable connecting structure of the adapting base and the stacking connection of the camp seat to match with the change of different adapting base without changing the volume of the clamping base and increase the range of contraction and expansion and width of the clamp seat in order to quickly and conveniently adjust the clamp and release of mobile phone, PDA, or palm game, extend the scope of application and applicability

The secondary objective of the present invention is to provide an improved clamping device for mobile phones, comprising an adapting base connected to an internal circuit at the lower end of a clamping base, and an inserting base with a connector electrically coupled to the upper end of the clamping base by means of an embedding engagement. By means of the easily replaceable connecting structure of the socket, the clamping device may change its socket to fit different electronic devices. Such arrangement can supply power or charge battery for mobile phones, PDAs, or palm games and attain the objectives of extending the scope of application and applicability, preventing economic waste, and reducing large inventory.

### BRIEF DESCRIPTION OF THE DRAWINGS

Other features and advantages of the present invention will become apparent in the following detailed description of the preferred embodiments with reference to the accompanying drawings, in which:

FIG. 1 is a perspective diagram of an improved clamping device for mobile phones according to a preferred embodiment of the present invention.

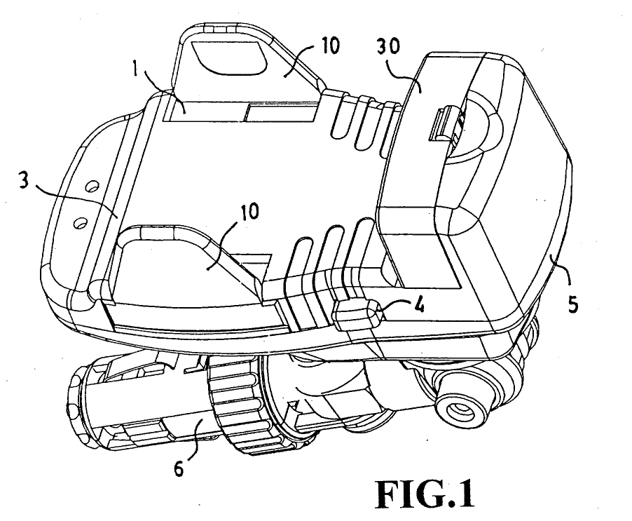

FIG. 2 is a perspective diagram of the disassembled parts of an improved clamping device for mobile phones according to a preferred embodiment of the present invention.

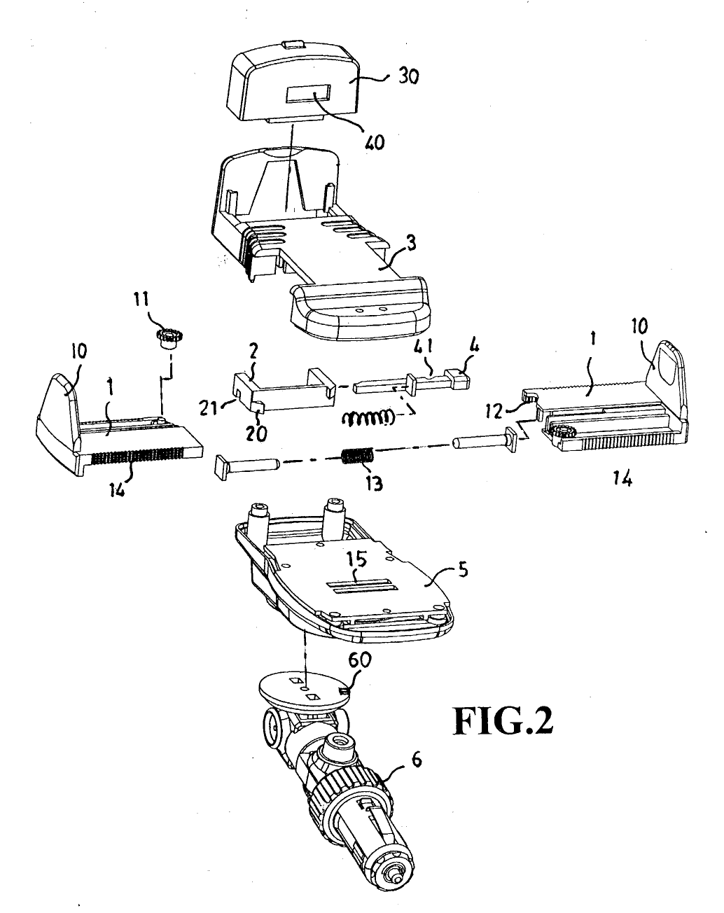

FIG. 3 is a perspective diagram of some disassembled parts of an improved clamping device for mobile phones according to a preferred embodiment of the present invention.

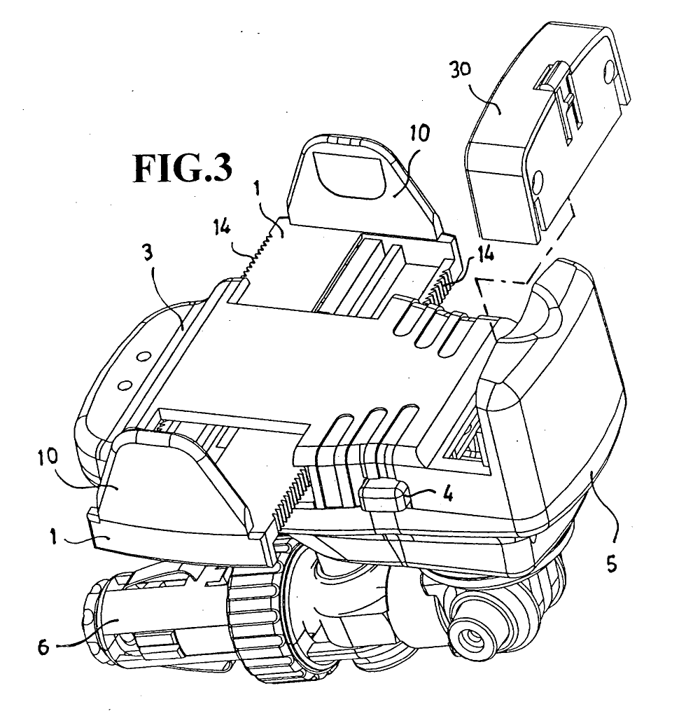

FIG. 4 is a perspective diagram of the clamping base according to the present invention.

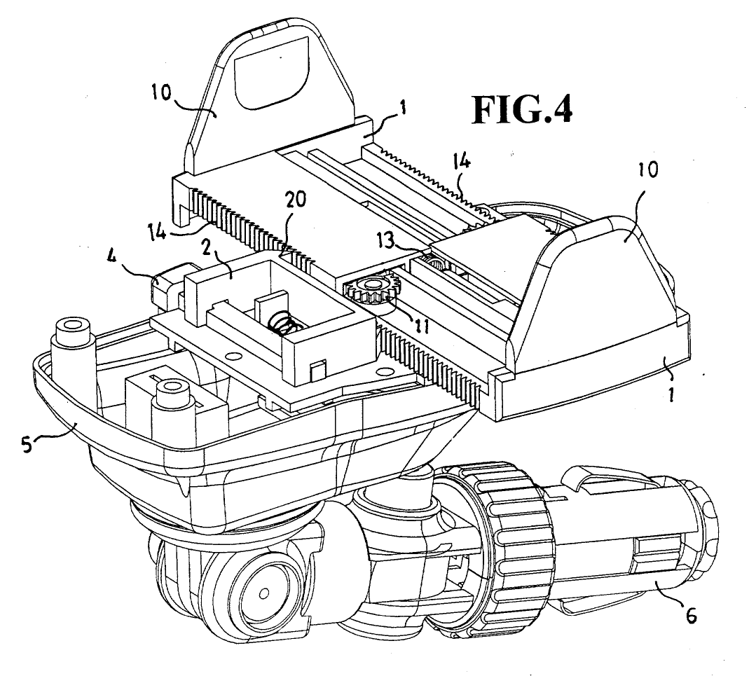

### DETAILED DESCRIPTION OF THE PREFERRED EMBODIMENTS

Referring to the figures, the improved clamping device for mobile phone of the present invention comprises a clamp seat 1, a secure seat 2, a press rod 4, a clamping base 3, 5, and a inserting base 6, which can be inserted into the cigarette lighter socket in a car or installed onto the panel of a car. A stop element or a notch 60 is disposed between the inserting base 6 and the clamping base 5 such that the clamping device can be rotated reciprocally within a specific angle. When the clamping device is inserted into the cigarette lighter socket of a car, it can electrically connect to the electric current or the internal circuit of the car. A surface base with different levels at the front and at the back is disposed between the clamping bases 3, 5, and a compression spring 13 disposed between the front and the back levels and sliding along a groove 15 of a contractible clamp seat 1. A side portion 10 on each of the two sides of the clamp seat 1 is protruded outside the clamping base 3, 5. Unidirectional rack teeth 14 aslant towards one side are disposed respectively on both sides of the clamp seat 1, and an elastic secure seat 2 is disposed on the side of the rack teeth 14. The secure seat 2 uses an upper element and a lower stop element 20 to project into the rack teeth 14 of the clamp seat 1 and stack onto the secure seat 1, such that the clamp seat 1 can only displace and clamp inwardly for the fixing. The rear end of the secure seat 2 has a slanting notch 21, and the slanting notch 21 has an elastic press rod 4, and the press rod 4 also defines the corresponding slanting notch 41 to drive the secure seat 2 to move back and forth. This section is similar to that disclosed in the U.S. Pat. No. 5,903,645. An adapting base 30 connected to an internal circuit at the lower end of a clamping base 3, 5, and an inserting base 4 with a connector 40 electrically coupled to the upper end of the clamping base 3 by means of an embedding engagement for battery charge and receiving sound or changing volume. Further, a guide wheel 11 is disposed on the clamping base 1 for retarding and smoothing the displacement of its sliding, and a plurality of serrations 12 are disposed on the side edge of the clamp seat 1.

If this invention only has a fixed clamping function for its practical application, users may insert the inserting base 6 into the cigarette lighter socket or on the panel of a car. When the press rod 4 displaces, the aslant notch 41 and the aslant groove 21 work together to drive and push the secure seat 2 backward, such that the upper and lower stop elements 20 are pushed to separate the rack teeth 14 of the clamp seat 1. Since the clamp seat 1 is pushed by the elastic force of the compression spring 13, a guide wheel 11 and a plurality of serrations 12 are linked and rapidly spread out along the sliding groove 15. Since the clamp seat 1 is coupled by stacking when it is engaged, its width will be doubled when it is pulled. If an object such as a mobile phone, a PDA, or a palm game is placed between the clamping bases 3, 5 of the clamp seat 1, the user only needs to clamp the clamp seat 1 such that the side portions 10 move towards the middle. The unidirectional aslant rack teeth 14 works with the upper and lower stop elements 20 of the secure seat 2 for the stop effect, and the clamp seat 1 only displaces and clamps inwardly to clamp and fix the object. If the user wants to release the clamped object, the user just needs to press the press rod 4 to rapidly open up the clamp seat 1 to expand and narrow the scope and width of the clamping bases 3, 5 without changing the volume of the clamping base 3, 5 to fit different mobile phones, PDAs, or palm games.

If this invention is applied to make a device with battery charging and changing sound volume, an adapting base 30 connected to an internal circuit and disposed at the lower end of the clamping bases 3,5, and an inserting base 4 with a connector 40 electrically coupled to the upper end of the clamping base 3, 5 by means of an embedding engagement such that the clamping object can be inserted into the connector 40 of he inserting base 4 to provide an external connection for battery charging and changing sound volume. Furthermore, the clamping with the easily replaceable assembling structure of the inserting socket provides an inserting socket that can be changed to fit different clamping object simply and quickly to attain the objectives of supplying the power or charging the battery for mobile phones, PDAs, or palm games, preventing economic waste, and reducing large inventory.

While the present invention has been described by the most practical and preferred embodiments, it is understood that this invention is not limited to the disclosed embodiments but is intended to cover various arrangements included within the spirit and scope of the broadest interpretations and equivalent arrangements.

In summation of the above description, the present invention herein enhances the performance than the conventional structure and further complies with the patent application requirements and is submitted to the Patent and Trademark Office for review and granting of the commensurate patent rights.

What is claimed is:

1. An improved clamping device for mobile phones, comprising:
a clamp seat, being a carrier and having a side portion on both sides for adjusting and fixing a clamping object; and
an inserting base, disposed at the bottom of said clamp seat and coupled to a cigarette lighter socket of a car or a panel of a car for an electric connection with an internal circuit and an electric current of the car when coupling said inserting base; characterized in that a compression spring being disposed and clamped within said clamp seat capable of sliding in a groove of said clamp seat; a side portion respectively disposed on both sides and protruded outside said clamping base; a plurality of unidirectional rack teeth aslant towards one side disposed respectively on both sides of said clamp seat; an elastic secure seat disposed on the side of the rack teeth; said secure seat using an upper stop element and a lower stop element to project into the rack teeth of said the clamp seat and stacking onto said secure seat, such that the clamp seat displacing and clamping inwardly for the fixing; the rear end of said secure seat having a slanting notch, and said slanting notch having an elastic press rod, and said press rod defining the corresponding slanting notch to drive the secure seat to move back and forth.

2. The improved clamping device for mobile phones of claim 1, wherein said clamp seat at its lower end comprises an adapting base electrically coupled to the internal circuit and an inserting base with a connector for electrically coupling said adapting base by an embedding engagement.

3. The improved clamping device for mobile phones of claim 1, wherein said clamp seat comprises a guide wheel and a plurality of serrations respectively disposed on the side edge of said clamp seat for the engagement with said guide wheel.

4. The improved clamping device for mobile phones of claim 1, wherein said inserting base and said clamp seat comprise a stop element or a notch for keeping said clamping base to rotate reciprocally within a predetermined angle.
